(19) United States
(12) Patent Application Publication
(10) Pub. No.: US 2010/0226774 A1
(43) Pub. Date: Sep. 9, 2010

(54) Wind turbine control system and apparatus

(76) Inventor: Kenneth James Deering, Seattle, WA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/660,888

(22) Filed: Mar. 5, 2010

(30) Foreign Application Priority Data
Feb. 25, 2009 (AU) 2009 900827
Feb. 25, 2009 (AU) 2009 900828
Feb. 25, 2009 (AU) 2009 900830
Feb. 25, 2009 (AU) 2009 900831
Feb. 25, 2009 (AU) 2009 900832

(51) Int. Cl. F03B 3/14

(52) U.S. Cl. 416/117

(57) ABSTRACT

A wind turbine and system related to the control of wind turbines. The wind turbine device is comprised of a plurality of blades arranged for rotation about an axis. During use the blades are moveable between different incline positions relative to a plane substantially normal to the axis. The control system allows for the detection of the rotational speed of the blades about the axis and for selectively resisting movement of the blades to a different incline position based on a comparison of the rotational speed with a target speed value determined by the energy output level for the turbine.

### FIELD OF THE INVENTION

This application claims priority to Australian Provisional Patent Number 2009 900828 filed Feb. 25, 2009, and Australian Provisional Patent Number 2009 900827 filed Feb. 25, 2009, and Australian Provisional Patent Number 2009 900831 filed Feb. 25, 2009, and Australian Provisional Patent Number 2009 900830 filed Feb. 25, 2009, and Australian Provisional Patent Number 2009 900832 filed Feb. 25, 2009, each of which is respectively incorporated herein in its entirety by reference.

The present invention relates to a wind turbine. More particularly, the device disclosed herein and described relates to systems for controlling a wind turbine.

### BACKGROUND OF THE INVENTION

A typical wind turbine includes a rotor with multiple blades. When the blades are exposed to a sufficient level of airflow, aerodynamic forces created by the blades causes the rotor to rotate about an axis. To enhance the rotor's exposure to airflow, the rotor may be elevated to a certain height above ground by a support structure (e.g. a tower). The rotational energy of the rotor can be harnessed in many ways, for example, to produce electricity. In order for the energy captured by the rotor to be harnessed efficiently, the rotor needs to able to rotate both under low wind speed and high wind speed conditions.

However, during high wind speed conditions (or where wind speed is volatile), a greater level of force is applied to each of the blades. This in turn applies a greater level of stress to the coupling mechanism between the blades and the hub of the rotor. A rotor that frequently operates in such wind conditions is likely to experience premature mechanical wearing (or failure) of the blade coupling mechanism, which results in more regular down time for repairs or maintenance, and a reduced overall power output generated by the wind turbine.

There are proposals that to attempt to reduce the stress experienced by the rotor during a range of wind conditions. For example, U.S. Pat. No. 5,584,655 describes a rotor using flap actuators to actively and controllably change the cone angle of the blades. The blades may freely pivot through a range of cone angles (e.g. in response to different wind conditions). However, this configuration may not be suitable in low wind speed conditions since the rotor will rotate at lower speed and may not generate sufficient centrifugal force to bias the blades outwards. Also, U.S. Pat. No. 5,584,665 does not describe any attempts to control or regulate blade flapping.

As such, there is an unmet need for turbine blade control system which adjusts the blades to allow the rotor to rotate both under low wind speed conditions, as well as high wind speed conditions. Such a control should endeavor to adjust the blades during high wind speed conditions to alleviate the greater level of force communicated by the wind to each blade, as well as make adjustments during low wind speeds to maximize force imparted by the blades to the rotor to thereby concurrently maintain rotation of the engaged rotor.

### SUMMARY OF THE INVENTION

The representative embodiments described herein can be used in a wind turbine having a hinge feature at the base end of each blade (referred to as a flapping hinge). A wind turbine rotor comprised of two or more such hinged blades can be referred to as a flapping hinge rotor.

The representative embodiments described herein employ the use of a hydraulic actuator located in proximity to each flapping hinge to controllably regulate, maintain or adjust the flap angle position of the associated blade. The hydraulic actuator employs valves which may be opened, closed or throttled by means of command signals issued by the turbine control computer or control system.

During power production operation, when the rotor rotation speed is above a certain minimum, appropriate valves in the hydraulic actuator (e.g. flap motion restraint valves) are opened and thereby minimizes the resistance or regulation to blade flapping motions. This can be important because by so doing, bending moment loads imposed on the blade and other structural elements of the turbine are substantially diminished. When the turbine rotor is not rotating, particularly during conditions of extreme wind events, appropriate valves in the hydraulic actuator (e.g. flap motion restraint valves) are closed and blade flapping motions are restrained or prevented.

In preparation for starting the turbine from rest, valves which enable adjustment of blade flap angle may be utilized to position each blade to the appropriate position to enable initiation of rotor rotation and acceleration to normal operating speed (e.g. flap actuator extend valves and flap actuator retract valves).

To execute a shut-down of the turbine from operating rotor speed, appropriate valves (e.g. flap actuator extend valves) are initially activated to provide a bias moment in order to more effectively counteract moments induced by aerodynamic forces. As the rotor speed decreases during the shut-down process and upon reaching a designated rotation speed According to the present invention, there is provided a wind turbine including:

a plurality of blades arranged for rotation about an axis, said blades in use being moveable between different incline positions relative to a plane substantially normal to said axis; and a control system for:

i) detecting a rotational speed of the blades about the axis; and

ii) selectively resisting movement of the blades to a different incline position of said blades based on said rotational speed of said blades.

The present invention also provides a wind turbine including:

a plurality of blades arranged for rotation about an axis, said blades being selectively moveable between different incline positions relative to a plane substantially normal to said axis;

a sensor for detecting a rotational speed of said blades about said axis;

a controller for selectively resisting movement of said blades to a different incline position based on a comparison of said rotational speed with a target speed value determined based on an energy output level for said turbine.

The foregoing has outlined rather broadly the more pertinent and important features of the device and method herein for controlling a wind turbine in order that the detailed description of the invention that follows may be better understood so that the present contribution to the art may be more fully appreciated. Additional features of the invention will be described hereinafter which form the subject of the claims of the invention. It should be appreciated by those skilled in the art that the conception and the disclosed specific embodiment may be readily utilized as a basis for modifying or designing other modular systems for blade control which may be employed on a wind turbine. It should also be realized by those skilled in the art that such equivalent constructions and methods do not depart from the spirit and scope of the invention as set forth in the appended claims.

In this respect, before explaining at least one embodiment of the turbine control invention in detail, it is to be understood that the invention is not limited in its application to the details of construction and to the arrangement of the components and steps in the methods set forth in the following description or illustrated in the drawings. The invention herein is capable of other embodiments and of being practiced and carried out in various ways and the individual component portions thereof may be employed singularly or in concert. Also, it is to be understood that the phraseology and terminology employed herein are for the purpose of description and should not be regarded as limiting.

### THE OBJECTS OF THE INVENTION

It is therefore an object of the present invention to provide a control system for blades on a wind turbine which adapt the angle of the blades to provide maximum force in low speed winds which features individual components of the system which may be employed singularly or in combinations.

It is another object of this invention to provide such a control system which may be employed to adjust the blades during high speed winds to protect the engaged mechanical components from over-stress while concurrently maximizing the force communicated to rotate the rotor to take advantage of the higher energy potential of high speed winds.

It is a further object of this invention, to provide such a modular control system which also minimizes costs and maintenance.

The foregoing has outlined some of the more pertinent objects of the invention. These objects should be construed to be merely illustrative of some of the more prominent features and applications of the intended blade control invention. Many other beneficial results can be attained by applying the disclosed method and control device in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

Representative embodiments of the present invention are herein described, by way of example only, with reference to the accompanying drawings, wherein:

FIG. 1 is a rear view of a wind turbine;

FIG. 2 is a side view of the wind turbine shown in FIG. 1;

FIG. 3 is a top view of the connecting structures between the blades and the hub;

FIG. 4 is a block diagram of a control system;

FIGS. 5, 6, 7 and 8 are block diagrams showing the components in a hydraulic flap actuator configured in a parked state, start-up state, power-production state, and shutdown state respectively; and

FIG. 9 is a block diagram showing the components in two different hydraulic flap actuators configured for inter-operation with each other during power production.

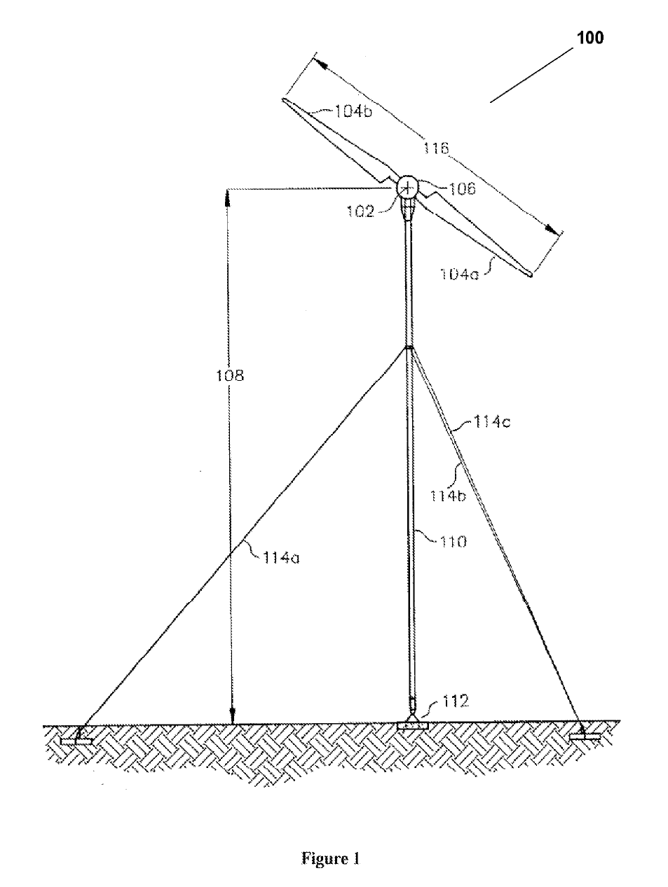

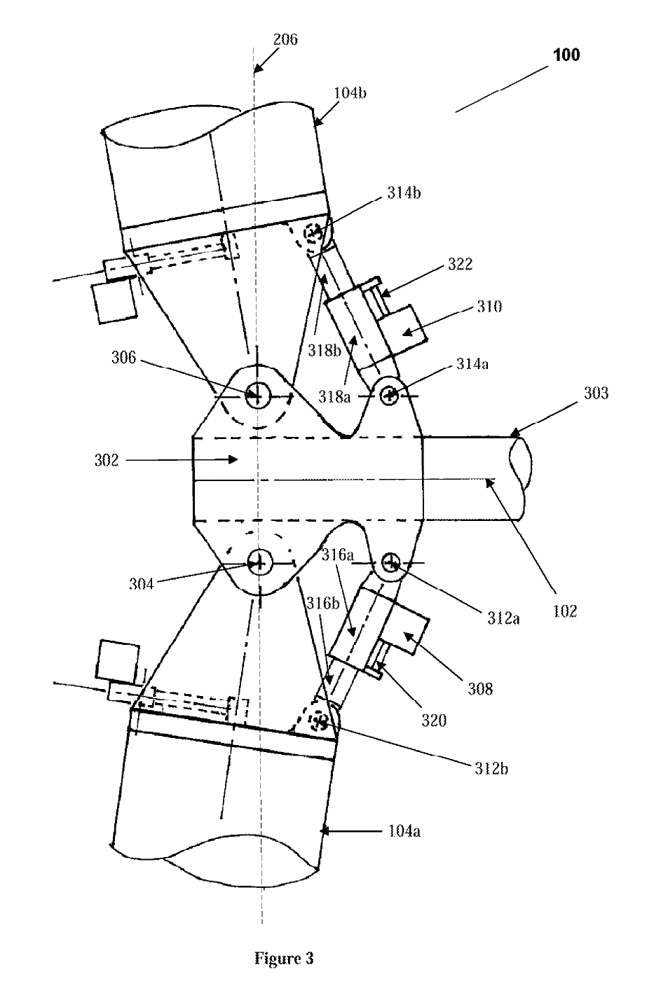

Referring now to the drawings 1-9, wherein similar parts of the invention are identified by like reference numerals, there is shown in FIG. 1 wind turbine 100, which includes a plurality of blades 104a and 104b coupled to a hub 302 (see FIG. 3) located within a housing 106. The blades 104a and 104b are rotatable (e.g. together with the hub 302) about a rotational axis 102. A tower 110 supports the housing 106 at a height 108 about the ground. The height 108 should be greater than half the span length 116 of the blades 104a and 104b to avoid the blades from hitting the ground. The tower 110 has a base portion 112 that is connected to the ground. The tower 110 may have one or more guide wires 114a, 114b and 114c connecting the tower 110 to anchors on the ground to help secure the tower 110 (e.g. when operating in high wind conditions).

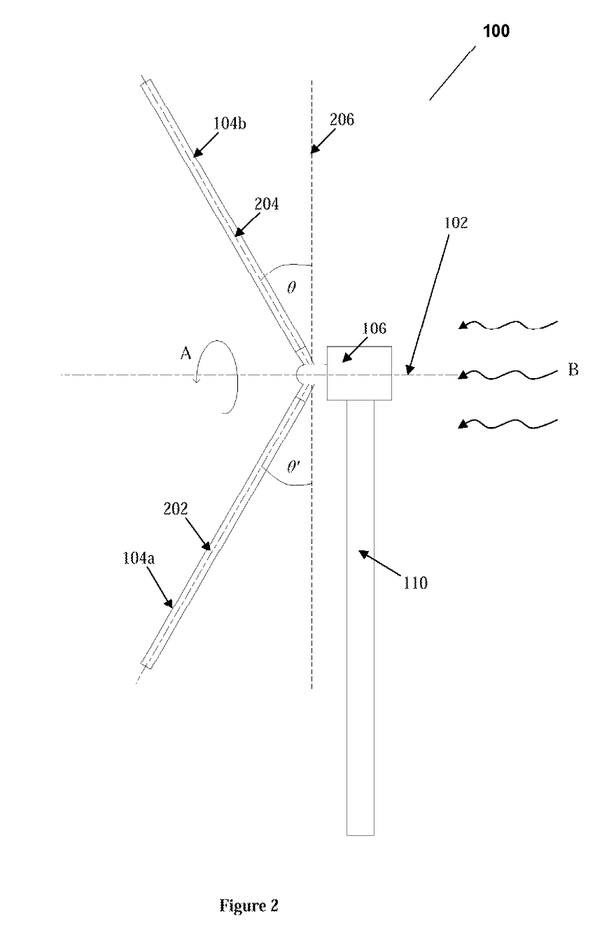

FIG. 2 is a side view of the wind turbine 100 shown in FIG. 1. The blades 104a and 104b of the wind turbine 100 rotate about a rotational axis 102 in a rotational direction (indicated by arrow A) in reaction to the force exerted onto the blades 104a and 104b by wind flowing in a direction indicated by the arrows B. Each of the blades 104a and 104b has a longitudinal axis 202 and 204 that runs along the length of each blade. Each blade 104a and 104b has an end portion that is pivotally coupled to a hub 302 (as shown in FIG. 3).

Each of the blades 104a and 104b can be moved or adjusted to an incline position where the length of the blade 104a and 104b is inclined at a flap angle (represented by θ and θ′ in FIG. 2) relative to a rotational plane 206 that is substantially normal to the rotational axis 102. For example, the blades 104a and 104b may be initially configured to a first incline position (e.g. with a minimal flap angle) so that the blades 104a and 104b can rotate substantially in parallel with the rotational plane 206. However, during rotation, the blades 104a and 104b may be moveable to a different incline position (e.g. to a greater flap angle up to a predetermined maximum flap angle). During rotation, the flap angle of each blade 104a and 104b may vary due to a combination of centrifugal forces and aerodynamic forces exerted onto each respective blade 104a and 104b by the wind.

FIG. 3 is diagram showing an example of the connecting structures between the blades 104a and 104b and the hub 302. The hub 302 is the structure that couples the blades 104a and 104b to a drive shaft 303. The rotation of the blades 104a and 104b causes the hub 302 and the drive shaft 303 to rotate. One end of the drive shaft 303 may be coupled to an Each blade 104a and 104b has an end portion that is pivotally coupled to the hub 302, so that each blade 104a and 104b can pivot about a respective pivot axis 304 and 306. The incline position of each blade 104a and 104b (relative to the plane of rotation 206) is controlled by one or more actuators 308 and 310, which controls (and allows adjustments of) the relative distance between a pivot point 312b and 314b of a blade 104a and 104b and a pivot point 312a and 314a of the hub 302.

In one representative embodiment, the incline position of all blades 104a and 104b of the wind turbine 100 may be controlled by a single actuator 308 or 310. In another representative embodiment, shown in FIG. 3, the incline position of each blade 104a and 104b may be respectively controlled by a different actuator 308 and 310. Each of the actuators 308 and 310 may be hydraulic actuator, which moves a driving arm 320 and 322 towards or away from the respective actuator 308 and 310 by controlling the application of hydraulic pressure.

In the representative embodiment shown in FIG. 3, each actuator 308 and 310 controls the extension or retraction of an arm assembly, which moves the incline position of the blades 104a and 104b to a greater or lesser flap angle respectively. Each arm assembly includes a first arm portion 316a and 318a having a bore formed therein for receiving a smaller second arm portion 316b and 318b. The first and second arm portions 316a, 316b, 318a and 318b can move towards or away from each other (e.g. under the control of an actuator 308 and 310) in order to retract or extend the overall length of the arm assembly. For example, the actuator 308 and 310 may be securely coupled to the first arm portions 316a and 318a, and the end of the arms 320 and 322 may be securely coupled to the second arm portions 316b and 318b (or vice versa). In this configuration, extension or retraction of each actuator arm 320 and 322 causes the arm assembly to extend or retract accordingly.

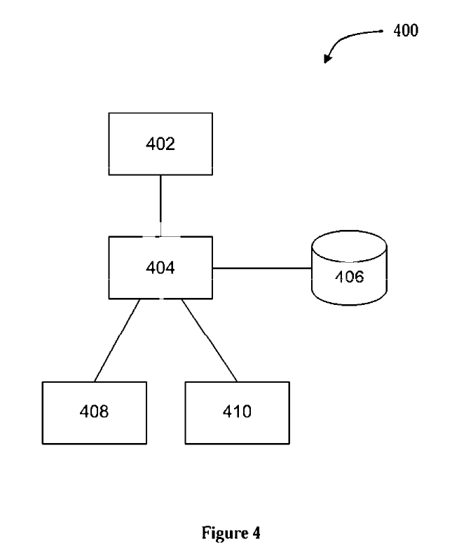

An end portion of each first arm portion 316a and 318a is pivotally coupled to the hub 302, so that each first arm portion 316a and 318a can pivot about a respective pivot point 312a and 314a on the hub 302. FIG. 4 is a block diagram showing the components of a blade control system 400 for controlling the flapping motion of the blades 104a and 104b. The blade control system 300 includes a sensor 402, processor 404, data store 406, and one or more flap control actuators 408 and 410 (where in the representative embodiment shown in FIG. 4, there is a different flap control actuator 408 and 410 for each respective blade 104a and 104b). The processor 404 may be part of a standard industrial duty computer running a real-time operating system. The processes performed by the processor 404 may be provided by way of computer program code (e.g. in languages such as C++ or Ada). However, those skilled in the art will also appreciate that the processes performed by the processor 404 can also be executed at least in part by dedicated hardware circuits, e.g. Application Specific Integrated Circuits (ASDICS) or Field-Programmable Gate Arrays (FPGAs).

The sensor 402 detects a rotational speed of the blades 104a and 104b about the rotational axis 102, and generates detected speed data representing a rotational speed of the blades 104a and 104b. The detected speed data is provided to the processor 404. The processor 404 then accesses, from a data store 406, target speed data representing a target speed value. The data store 406 refers to any means for storing data (including, for example, a hard disk, flash memory, Random Access Memory (RAM), Read Only Memory (ROM) and one or more data files).

The target speed value represents a predetermined speed of rotation of the blades 104a and 104b, and which may be determined based on an energy output level to be produced by the rotation of the blades 104a and 104b. For example, the target speed value may represent a minimum rotational speed of the blades 104a and 104b in order for a generator (coupled to the hub 302) to generate a predetermined level of energy output. The level of energy output may be a maximum rated power output (e.g. of electricity) to be produced by the generator. Different wind turbines can be designed to produce different levels of rated power.

The processor 404 compares a first value represented by the detected speed data with a second value represented by the target speed data. If the first value is less than the second value, the processor 404 generates control data representing commands or instructions for adjusting the opening and/or closing of certain valves in each flap control actuator 408 and 410 in order to resist the blades 104a and 104b from moving to different incline positions. In this configuration, the flap control actuators 408 and 410 apply resistance to movements of the blades 104a and 104b in deviation from its current incline position. For example, the blades 104a and 104b may be securely held at a minimal incline position so that the blades 104a and 104b are rotatable along the rotational plane 206. This configuration is particularly useful during the start-up phase of the wind turbine 100, since the blades 104a and 104b (at a minimal incline position) have greatest exposure to the prevailing wind to drive the rotation of the blades 104a and 104b. By resisting blade flapping movements during the start-up phase, the aerodynamic forces exerted onto the blades 104a and 104b by the wind is more effectively translated into rotational motion.

Alternatively, if the first value is greater or equal to the second value, the processor 404 generates control data representing commands or instructions for adjusting the opening and/or closing of certain valves in each flap control actuator 408 and 410 in order to inhibit resistance to movement of the blades 104a and 104b to different incline positions. In this configuration, the blades 104a and 104b can move (with minimal resistance) to different incline positions relative to the rotational plane 206 (e.g. between a maximum and minimum incline position). The blades 104a and 104b are rotate at a speed that generates sufficient centrifugal force to bias the blades 104a and 104b outwardly (i.e. away from the rotational axis 102). The incline position of each blade 104a and 104b is determined by the balance between the centrifugal force on each blade and the load on the relevant blade 104a and 104b from the wind (in direction B).

The ability for the blades 104a and 104b to move to a different incline position (or flap) is particularly advantageous for power production. For example, if the wind turbine 100 receives a sudden gust of strong wind, the blades 104a and 104b can deflect to a different incline position to absorb at least some of the force of the wind, thus reducing the amount of force (and potentially damage) placed on the blade coupling mechanism that connects each blade 104a and 104b to the hub 302.

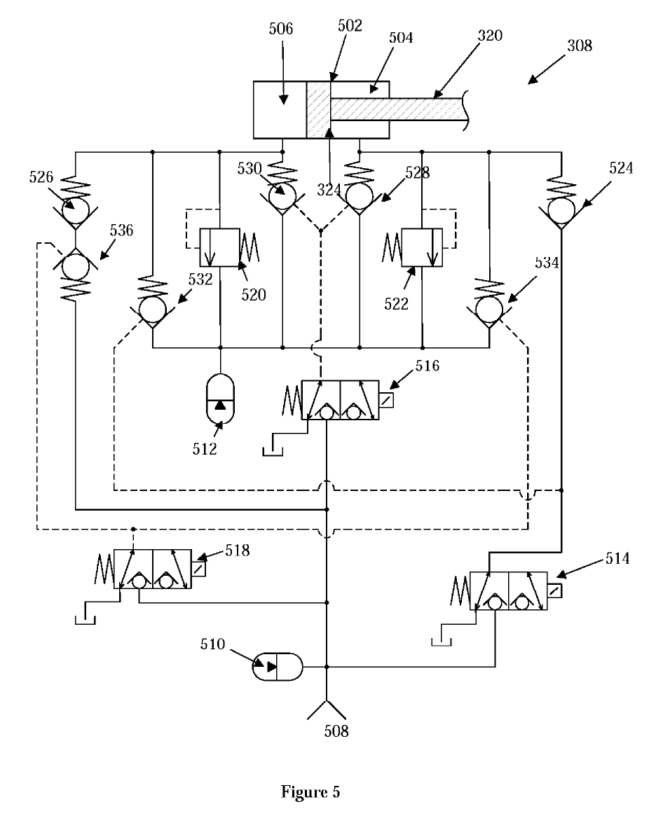

FIG. 5 is a block diagram showing the hydraulic components in a representative embodiment of an actuator 308 (when configured in a parked state). Each actuator 308 and 310 has the same components, and operate in the same way. The parked state represents the configuration where all valves of the actuator 308 and 310 are in the de-energized state.

The actuator 308 has a cylinder 502, which houses a piston 324 formed at one end of the arm 320. The cylinder 502 has a front end with an opening through which the arm 320 extends. The piston 324 divides the cylinder 502 into a front chamber 504 and a rear chamber 506. When hydraulic fluid is fed into the front chamber 504, the piston 324 is pushed away from the front end, which retracts the arm 320 into the cylinder 502. This causes the arm assembly to retract and position the blade 104a to an incline position with a smaller flap angle. When hydraulic fluid is fed into the rear chamber 506, the piston 324 is pushed towards the front end, which extends the arm 320 from the cylinder 502. This causes the arm assembly to extend and position the blade 104a to an incline position with a greater flap angle.

As shown in FIG. 5, the actuator 308 includes a high pressure source 508, low pressure source 510 and 512, a blade retract valve 514, a blade restraint valve 516, a blade extend valve 518, pressure releasing valves 520 and 522, one-way valves 524 and 526 and pilot valves 528, 530, 532, 534 and 536. The blade retract valve 514, blade restraint valve 516, and blade extend valve 518 each may be a solenoid controlled valve that can either be configured in an on state (allowing fluid to flow through the valve) or an off state (resisting fluid from flowing through the valve).

In the configuration shown in FIG. 5, the blade retract valve 514, blade restraint valve 516, and blade extend valve 518 are all on the off state. This prevents hydraulic fluid from the high pressure source 508 from adjusting the position of the arm 320. The arm 320 is therefore securely held in its current position (relative to the cylinder), which resists movement of the corresponding blade 104a to a different incline position.

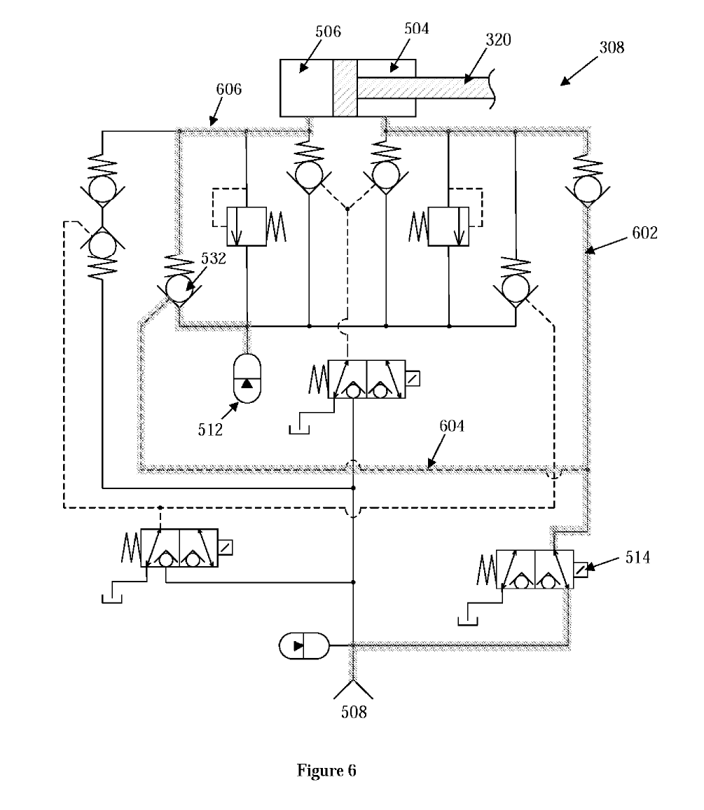

FIG. 6 is a block diagram showing the hydraulic components in a representative embodiment of an actuator 308 (when configured in a start-up state). In this state, the blade retract valve 514 is energized (under the control of the control data from the processor 404). Hydraulic fluid from the high pressure source 508 flows via path 602 into the front chamber 504. At the same time, hydraulic fluid travels via path 604 to open the pilot valve 532, which allows any hydraulic fluid in the rear chamber 506 to flow (via path 606) into the low pressure source 512. In this configuration, the arm 320 (and arm assembly 316a and 316b) retracts and moves the blade 104a to an incline position with a minimal flap angle.

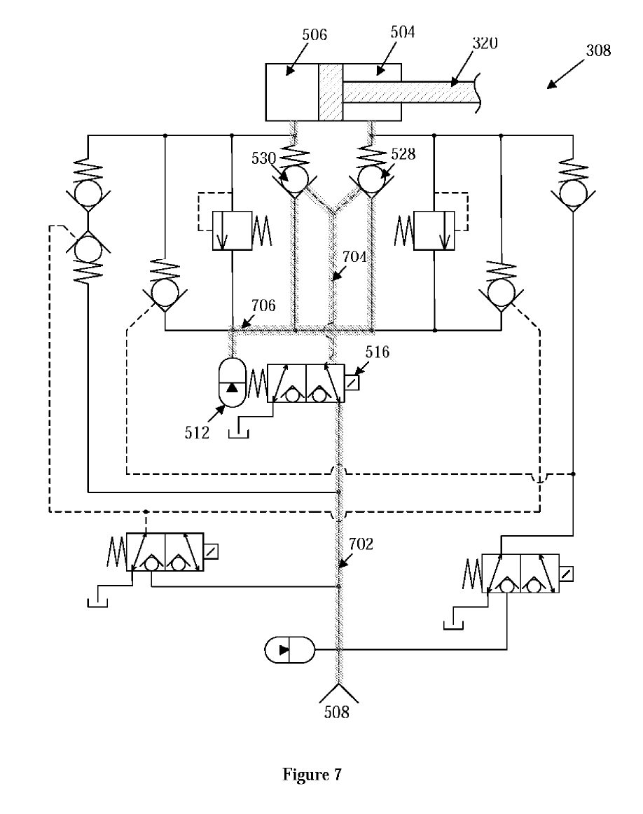

FIG. 7 is a block diagram showing the hydraulic components in a representative embodiment of an actuator 308 (when configured in a power-production state). In this state, the blade restraint valve 516 is energized (under the control of the control data from the processor 404). Hydraulic fluid from the high pressure source 508 flows via paths 702 and 704 to open the pilot valves 528 and 530. This establishes a path 706 that allows the hydraulic fluid in the front chamber 504 to flow into the rear chamber 506 (and vice versa) with minimal resistance. Such flow is also assisted by hydraulic pressure provided by the low pressure source 512. In this configuration, the arm 320 (and arm assembly 316a and 316b) can extend or retract with minimal resistance. This allows the blade 104a to move to any incline position depending on the centrifugal and aerodynamic forces exerted on the blade 104a.

In a representative embodiment, the processor 404 only generates a control data for energizing the blade restraint valve 516 if the value represented by the detected speed data is equal to or greater than the target speed value represented by the target speed data. For example, the target speed value should ideally represent a rotational speed where the blades 104a and 104b have developed sufficient centrifugal force to bias the blades 104a and 104b away from the rotational axis 102.

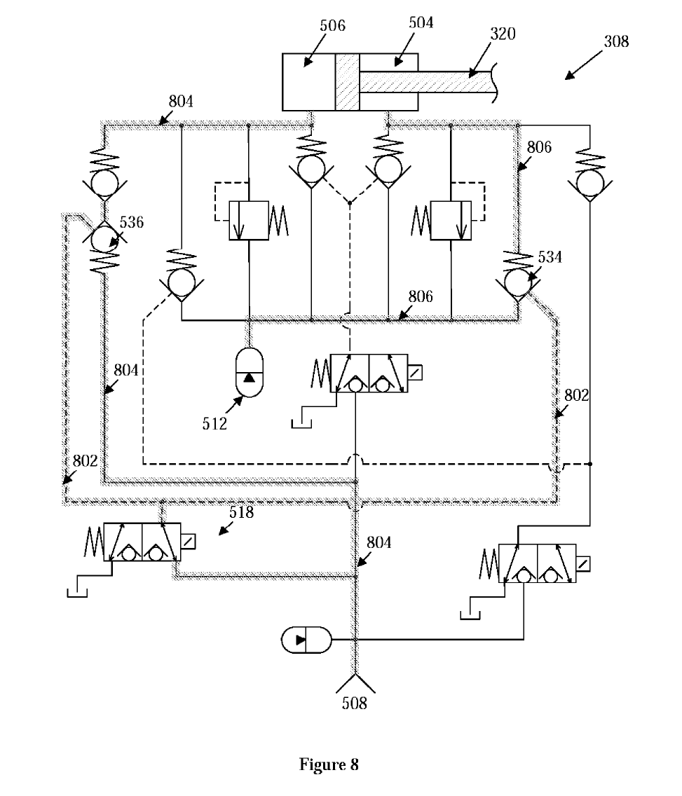

FIG. 8 is a block diagram showing the hydraulic components in a representative embodiment of an actuator 308 (when configured in a shut-down state). In this state, the blade extend valve 518 is energized (under the control of the control data from the processor 404). Hydraulic pressure from the high pressure source 508 flows via path 802 to open the pilot valves 534 and 536. When the pilot valve 536 open, hydraulic fluid from the high pressure source 508 flows (via path 804) into the rear chamber 506 of the cylinder 502. When the pilot valve 534 opens, hydraulic fluid in the front chamber 504 flows (via path 806) into the low pressure source 512. In this configuration, the arm 320 (and arm assembly 316a and 316b) extends and moves the blade 104a to an incline position with a greater flap angle.

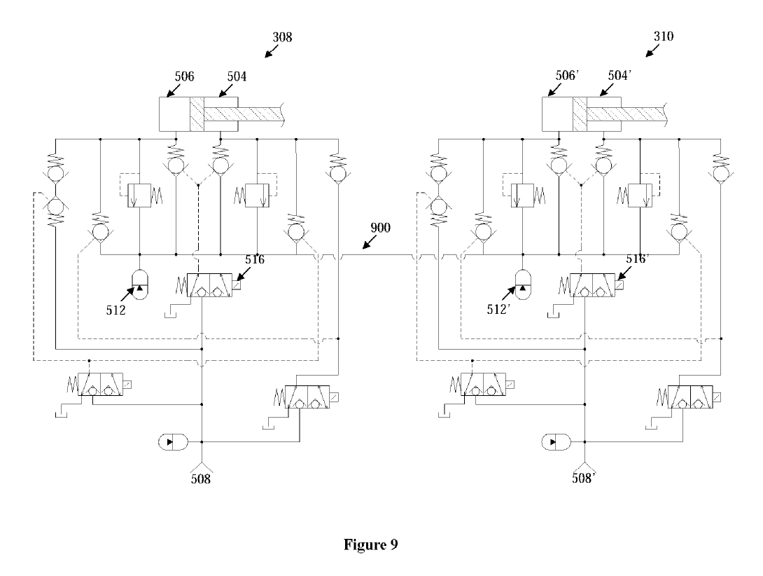

FIG. 9 is a block diagram showing two different actuators 308 and 310 that are connected together by a path 900. During power production, the blade restraint valves 516 and 15 516′ are energized for operation in a manner similar to that described with reference to FIG. 7. By having a path 900, the hydraulic fluid from the front and rear chambers 504, 504′, 506 and 506′ of both actuators 508 and 510 can flow into either of the low pressure sources 512 and 512′. This is particularly advantageous since, for example, in the event that one of the blades 104a or 104b experiences a sudden gust of wind (which applies a sudden increase in pressure in 20 one of the front chambers 504 or 504′) this pressure in the front chambers 504 and 504′ is almost evenly distributed between the low pressure sources 512 and 512′. This reduces the overall pressure applied to any one of the low pressure sources 512 and 512′, and thus reduces 16 the stress on the seals controlling the flow into and out of each of the low pressure sources 512 and 512′. As a result, the path 900 can help extend the serviceable life of the low pressure sources 512 and 512′.

Modifications and improvements to the invention will be readily apparent to those skilled in the art. Such modifications and improvements are intended to be within the scope of this invention. For example, although the present specification describe a downwind turbine configuration (i.e., the rotor is placed downwind from the tower when in power production), the present invention may also be applied to a turbine with upwind configuration (i.e., the rotor is placed upwind from the tower when in power production). The algebraic sign convention employed in the figures and descriptions herein define flap angle with reference to a rotor plane and the incident wind direction when in power production. When defined in this manner the descriptions presented apply equally to downwind and upwind configuration turbines.

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

The word comprising and forms of the word comprising as used in this description and in the claims does not limit the invention claimed to exclude any variants or additions.

What is claimed is:

1. A wind turbine including:
a plurality of blades arranged for rotation about an axis, said blades in use being moveable between different incline positions relative to a plane substantially normal to said axis; and
a control system for:
i) detecting a rotational speed of the blades about the axis; and
ii) selectively resisting movement of the blades to a different incline position of said blades based on said rotational speed of said blades.

2. A wind turbine as claimed in claim 1, wherein said control system selectively resists movement of said blades to a different incline position based on a comparison of the measured rotational speed with a target speed value, the target speed value being determined based on an energy output level for said turbine.

3. A wind turbine as claimed in claim 2, wherein said control system resists movement of the blades to a different incline position when said rotational speed is less than said target speed value.

4. A wind turbine as claimed in claim 2, wherein said control system further inhibits the resistance to movement of said blades when said rotational speed is equal to or greater than said target speed value.

5. A wind turbine as claimed in claim 2, wherein: said turbine is coupled to a generator; and said target speed value corresponds to a minimum rotational speed of said blades for said generator to produce said energy output level.

6. A wind turbine as claimed in claim 1, wherein said control system includes at least one hydraulic actuator for movement of said blades to a different incline position.

7. A wind turbine as claimed in claim 6, wherein said control system includes a hydraulic actuator for each respective one of said blades.

8. A wind turbine as claimed in claim 6, wherein said control system, in response to positive hydraulic pressure, resists said movement of said blades to a different incline position.

9. A wind turbine as claimed in claim 6, wherein said control system, in response to positive hydraulic pressure, inhibits resistance to said movement of said blades to a different incline position.

10. A wind turbine as claimed in claim 6, wherein each said actuator is adjustable between: an extended position for driving a corresponding one of said blades to a maximum said incline position; and a retracted position for driving the corresponding blade to a minimum said incline position.

11. A wind turbine as claimed in claim 1, wherein each of said blades have an end portion hingedly coupled to a rotatable hub, wherein said blades are rotatable with said hub about said axis.

12. A wind turbine including:
a plurality of blades arranged for rotation about an axis, said blades being selectively moveable between different incline positions relative to a plane substantially normal to said axis;
a sensor for detecting a rotational speed of said blades about said axis;
a controller for selectively resisting movement of said blades to a different incline position based on a comparison of said rotational speed with a target speed value determined based on an energy output level for said turbine.
